(19) United States
(12) Patent Application Publication
(10) Pub. No.: US 2026/0338212 A1
(43) Pub. Date: Oct. 29, 2026

(54) Fastener Clip

(71) Applicant: Illinois Tool Works Inc., Glenview, IL (US)

(72) Inventor: Victor Diez Herrera, Sabadell (ES)

(21) Appl. No.: 19/573,929

(22) Filed: Mar. 20, 2026

(30) Foreign Application Priority Data
Apr. 23, 2025 (EP) 25172008.2
Mar. 2, 2026 (DE) 10 2026 108 473.7

(51) Int. Cl. F16B 2/24; B60H 1/00; F16B 21/08

(52) U.S. Cl. CPC F16B 2/243; F16B 21/086; B60H 1/00564; F16B 2/245

(57) ABSTRACT

A fastener clip for attaching a component to a vehicle chassis is provided. The fastener clip includes a top portion and at least one arm coupled to the top portion. The at least one arm includes at least one pressure surface configured to releasably engage and retain a portion of the component. The fastener clip is configured to secure the component to the vehicle chassis while permitting removal.

### RELATED APPLICATIONS

The present application claims the benefit of European Patent Application No. 25172008.2, filed Apr. 23, 2025, and German Patent Application No. 10 2026 108 473.7, filed Mar. 2, 2026, each titled “Fastener Clip,” the contents of which are hereby incorporated by reference.

### TECHNICAL FIELD

This clip belongs to the field of fasteners preferably used in the automotive industry, such as for fastening rigid plastic automobile ventilation ducts that must be anchored to the vehicle chassis.

### BACKGROUND

In the automotive industry, the needs for securing the various components and parts involved are numerous. Ducts are made of rigid plastic, for example, and incorporate holes for attaching a fastener to the chassis, such as a screw.

In the known art, for example, plastic screws are often used for this purpose, combined with a lag screw that is inserted into the inside of the panel. The screwing action expands the legs of the lag screw, opening them and preventing the part from protruding from the hole in the chassis, securing the screw by constricting the screw and its head or washer, which secures the application against the chassis and the lag screw. There are various developments of this part, mainly made entirely of plastic.

This design has several drawbacks. One of them is that, since it is made of plastic, after a period of use and stress on the parts, play occurs, which loosens the fastener.

### SUMMARY

The present disclosure relates generally to a fastener clip, substantially as illustrated by and described in connection with at least one of the figures, as set forth more completely in the claims.

According to the disclosure there is provided a fastener clip, suitable for attaching an element to a vehicle chassis, the fastener clip comprising: a top portion; and one or more arms in mechanical communication with the top portion; wherein the one or more arms comprise at least one pressure surface arranged to releasably grip a part. The fastener clip is sized and made resilient such that it may be fitted by hand, without additional tools, preferably by a finger press upon the top portion.

The top portion may have an aperture suitable to receive a tool. This allows the fastener clip to be intentionally removed and also for the top portion to be fitted flush with a substrate and the aperture provides a location for a tool to grasp the fastener clip in order to urge the fastener clip away from the substrate.

The at least one pressure surface may be arranged to release a grip upon a part upon a tool applying an extracting force to the fastener clip, and optionally, upon the aperture (other features may be provided for a tool to act upon for intentional fastener clip removal).

The one or more arms may be connected to the top portion by one or more legs. Optionally, the one or more legs may be connected to a perimeter edge of the top portion, and/or the one or more legs are arranged co-incident with a central axis and/or the aperture. The legs may provide the fastener clip with some structure to allow the arms to be inserted into a substrate.

The one or more arms may comprise at least one stop to prevent over insertion, and/or to provide reassurance of a successful insertion.

The at least one stop may be arranged proximate the top portion and/or the at least one stop may be located between the top portion and the pressure surface.

The one or more arms may have a shape substantially describing the number “5”, where the cross bar (to use terminology descriptive of the anatomy of a typeface) may form the stop.

The pressure surface may comprise a ramped surface to assist in insertion. Optionally, the ramped surface is arranged such that a first end of the ramp, proximate the top portion, is closer to a central axis relative to a second end of the ramp, distal to the top portion.

The aperture may be provided with a rim, optionally a reinforced rim. The rim allows the fastener clip to present a smooth surface to a finger press, reducing the risk of exposure to sharp edges.

The fastener clip may be formed from a single piece of material, preferably in a single manufacturing step. The fastener clip may be formed from a metal. The one or more arms, and optionally, or alternatively, the one or more legs may comprise embossed areas to increase the strength of the relevant parts. Embossed areas may be provided at any suitable location of the fastener clip to improve rigidity.

The fastener clip may comprise at least one tensioning finger to prevent unwanted vibrations once fitted and/or to allow the fastener clip to tolerate substrates of varying or inconsistent dimensions. The at least one tensioning finger may be arranged between the top portion and the pressure surface in order to, in use, pinch a part between the at least one tensioning finger and the pressure surface. The at least one tensioning finger may be twisted, or obliquely arranged, about a central axis relative to the one or more arms.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective representation of the embodiment of the clip of the present disclosure.

FIG. 2 corresponds to an elevation view from an orthogonal position of the clip in FIG. 1.

FIG. 3 corresponds to an elevation view from a lateral position of the clip in FIG. 1.

FIG. 4 shows a cross-section of FIG. 3, sectioning the piece with a vertical plane that runs from the center of the piece at its top through the lower base.

FIG. 5 is a top view of an exemplary embodiment of a fastener clip according to the present disclosure that has a circular central hole.

FIG. 6 shows a bottom view of the fastener clip, which may correspond to any of the preceding embodiments.

FIG. 7 illustrates a perspective representation of an embodiment of the clip of the present disclosure.

FIG. 8A illustrates a side view of a fastener clip.

FIG. 8B illustrates a further side view of a fastener clip.

FIG. 9A illustrates a top view of a fastener clip.

FIG. 9B illustrates a bottom view of a fastener clip.

FIG. 10A illustrates a tool for extracting a fastener clip.

FIG. 10B illustrates a cross section and expanded view of a tool attached to a fastener clip.

FIG. 11 illustrates a perspective representation of an embodiment of the clip of the present disclosure.

FIG. 12A illustrates a side view of a fastener clip.

FIG. 12B illustrates a further side view of a fastener clip.

FIG. 13A illustrates a top view of a fastener clip.

FIG. 13B illustrates a bottom view of a fastener clip.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Further, as used herein, the terms “connected”, “attached”, “coupled”, and “mounted” are intended to include direct connections between two members without any other members interposed therebetween, as well as indirect connections between members in which one or more other members are interposed therebetween. The terminology includes the words specifically mentioned above, derivatives thereof, and words of similar import.

The technical field addressed by this disclosure includes securing ventilation ducts to the vehicle chassis. One of the main objectives of this disclosure is to overcome the drawbacks of plastic fasteners as discussed above and to provide a metal fastener for this type of application.

Another objective of the present disclosure is to obtain a clip that can be adapted to different thicknesses of the fixing frame or surfaces to be joined.

Another objective of the present disclosure is that the clip can be removable, for example, using an extraction tool.

Finally, another objective of the present disclosure is that the clip be ergonomic and allow, if desired, manual installation with the pressure of a human finger.

The present disclosure comprises a fastener clip, of the type used in the automotive industry for fixing elements to the chassis of vehicles, specifically for fixing air ducts to the chassis. The fastener clip is metallic and has a top portion, which may be, but is not limited to having, a cup-shape with an optional central hole, and, starting from said top portion, a pair of opposite legs that extend until they join at a lower base distant from said top portion.

Said lower base is the starting point for ascending legs, in the direction of said top portion, which gives rise to lower pressure surfaces; the extension of said lower legs gives rise to upper wings, through the appropriate folds.

Viewed as a whole, the clip of the disclosure may have top portion with a cup-shaped upper surface that has chamfered edges and a central hole, and a set of downward extensions that form an inverted prismatic three-dimensional figure. That is, it has a “V” shape in section, which facilitates insertion into a hole in the chassis.

A surprising result of this clip is achieved because the fastener clip secures the accessory (e.g., Duct) to the chassis, trapping both between the inner and outer wings, like a sandwich. The elasticity obtained through the clip's constructive design allows it to automatically adapt to different thicknesses of the accessory-panel or accessory-chassis assembly.

Additionally, the fastener clip has been designed to allow its use in a “push-to-fit” operation, where installation can be done by applying pressure to the upper base or top portion, for example with the thumb, sinking the clip into the hole in the chassis. At this point, the elements are retained by the fastener clip, which flexibly compresses the internal and external parts of the chassis and accessory.

The fastener clip can be unlocked, allowing the fastener clip to be removed, using a tool, for example a hook inserted into the hole in the top portion (the hole may be present absent the cup) and compressing the lower leg portion toward the axial axis of the clip, allowing it to extend beyond the hole in the panel or chassis.

In this way, all the objectives envisioned by the disclosure have been achieved, providing an ergonomic, metallic fastening clip that is adaptable to various thicknesses of the surfaces to be joined, removable, and obtained from only one metal sheet, by die-cutting and deformation, resulting in an economical, high-performance fastener clip.

The present disclosure comprises a fastening clip, of the type used in the automotive industry for securing components to vehicle chassis, particularly for securing air ducts to the chassis. Said fastener clip (102) is composed of a deformed and die-cut metal sheet having a top portion (104) from which legs (106) extend downwards, which, when joined together, create a base (108) distant from and lower than said top portion (104). Said base (108) is the starting surface for arms (110) that form pressure surfaces (112) and fins (114). Said fastener clip 102 secures the component or accessory to the vehicle chassis, trapping both between said pressure surfaces (112) and said fins (114), like a sandwich.

The fastening described in the previous paragraph is elastic and adaptable to different thicknesses of the panel or surfaces to be joined. For example, the arms (110) have mobility in a direction parallel to the surface of said top portion (104) toward the vertical axial axis of the clip (102); the pressure surfaces (112) have some vertical flexibility, while the fins (114) are configured to have a wide range of flexibility in the vertical direction of the fastener clip 102 (i.e. Towards the top portion 104 away from the base 108), facilitating adaptation to different thicknesses of parts to be joined.

For example, and depending on the specific nature of the clip material (hardened steel, aluminum, etc.), the adaptability to the thicknesses of the surfaces to be attached can range from 3 mm to 6 mm, and more specifically, from 3.3 to 5.5 cm.

The fastener clip (102) is formed by a top portion (104) possibly with an aperture (116) and chamfered edges (118). A pair of opposing legs (106) emerge downward from said top portion (104) and join at a base (108) located below and away from said top portion (104). The top portion may be cup-shaped.

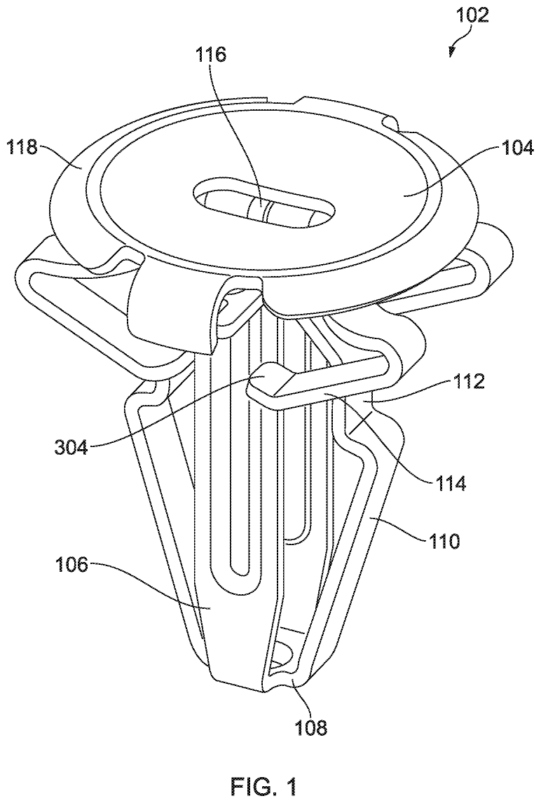

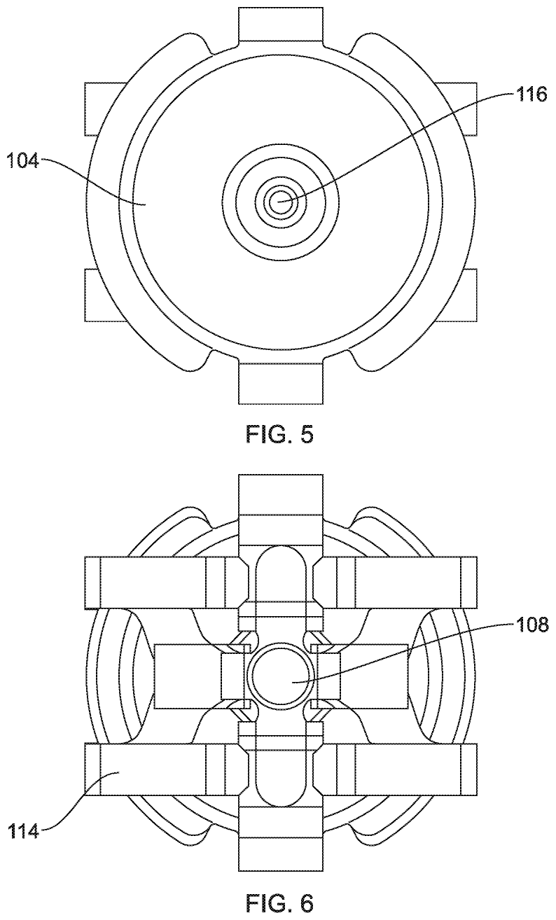

In FIG. 1, the aperture (116) is a slotted aperture, that is, generally rectangular in shape with curved short sides. This shape is designed to facilitate the insertion of an extraction tool. Naturally, said aperture (116) can, in other possible embodiments, have other shapes and sizes. For example, FIG. 5 shows a top view in which the top portion (104) may have a circular aperture (116).

The legs (106) form a seamless surface that extends from the top portion (104) and joins at said base (108). For this purpose, a joint (202), of any type, is provided, which closes and joins the different sections of said legs (106), providing greater structural strength to the assembly.

From said base (108), the legs (106) rise toward the top portion (104), creating both the pressure surfaces (112) and the fins (114) that work against the outer faces of the surfaces or panels to be joined. Said lower pressure surfaces (112) are formed with a slight inclination toward the center of the clip (102).

It can be clearly seen in the graphics that these surfaces have a slight inclination, which can be described as the section closest to a central axis (402) of the clip (102), which is closest to said top portion (104) and the opposite section being farthest from it. This inclination is configured to facilitate the extraction of the clip and the overcoming of the edge of the application hole when said arms (110) contract toward the central axis (402) of the clip (102).

For their part, said fins (114) are formed from the arms (110) that have a section that approaches the central axis 402 of the clip (102) and from which at least one flat section (302) emerges. In the embodiment shown in the graphics of each arm (110), two flat sections (302) emerge parallel to each other, being approximately parallel to said top portion (104), which, by bending themselves in the direction of the central axis (402) of the clip (102), form said fins (114), presenting an inclination with respect to said axis (402) of approximately 45°.

Overall, the clip (102) of the disclosure forms an inverted prismatic three-dimensional shape, that is, presenting a “V” shape in section, facilitating insertion into an application hole, starting from its narrow end at the base (108), and whose body progressively widens until reaching the top portion (104) of said clip (102).

The use of the clip of the present disclosure could not be more ergonomic. In fact, it is designed for manual installation, if preferred, without the use of any tools. It is sufficient, for example, to apply pressure to the top portion (104) with a finger, approximately 45 N, in the direction of the clip's aperture (116). This action allows the pressure surfaces (112) to extend beyond the edges of the aperture (116), to open away from the central axis (402) of the clip (102), and to lock, as in a sandwich, the panels or surfaces joined between said pressure surfaces (112) and said fins (114).

Fins (114) have inflected tips (304). The fins are generally arranged such that part of the fin proximate the central axis (402) of the fastener clip (102) is closer to the base (108) relative to part of the fin arranged distal from the central axis (402). The inflected tips (304), where present, reverse this and ensure the tip of the fin is arranged such that part of the inflected tips (304) which is proximate to the central axis (402) of the fastener clip (102) is closer to the top portion (104) relative to part of the inflected tip that is arranged distal from the central axis (402). The fins are connected to the arms by a linkage (306).

Removing the clip is also simple. Simply insert a suitable tool, such as a hook, through the aperture (116) in the top portion (104) to retract the arms (110) toward the central axis (402) of the clip (102). This action allows the clip (102) to be removed from the application hole by extending the pressure surfaces (112) beyond the edges of the installation hole. In this way, all the objectives envisioned by the present disclosure have been achieved, resulting in an ergonomic, metallic, elastic fastening clip that allows for flexible adaptation to different thicknesses of the surfaces to be joined, allowing for manual installation and is removable. The clip described allows for a secure and firm attachment that does not deteriorate over a reasonably long period of time, thanks to its structural nature, successfully coping with eventual wear caused by the forces exerted on the part.

Herein disclosed is a fastener clip, of the type used in the automotive industry for securing components to the vehicle chassis, specifically for securing air ducts to the chassis. The clip (102) is made from a deformed and die-cut metal sheet forming an upper top portion (104) from which legs (106) extend downwards, creating, when joined together, a base (108) distant from and lower than said top portion. Said base is the starting surface for arms (110) that form lower pressure surfaces (112) and upper fins (114). Said assembly secures the component or accessory to the vehicle chassis, trapping both between said lower pressure surfaces and said upper fins, as in a sandwich.

It is understood that in the present case, any details of the finish and shape that do not substantially modify the clip of the disclosure may be variable, primarily as described in the claims accompanying this specification.

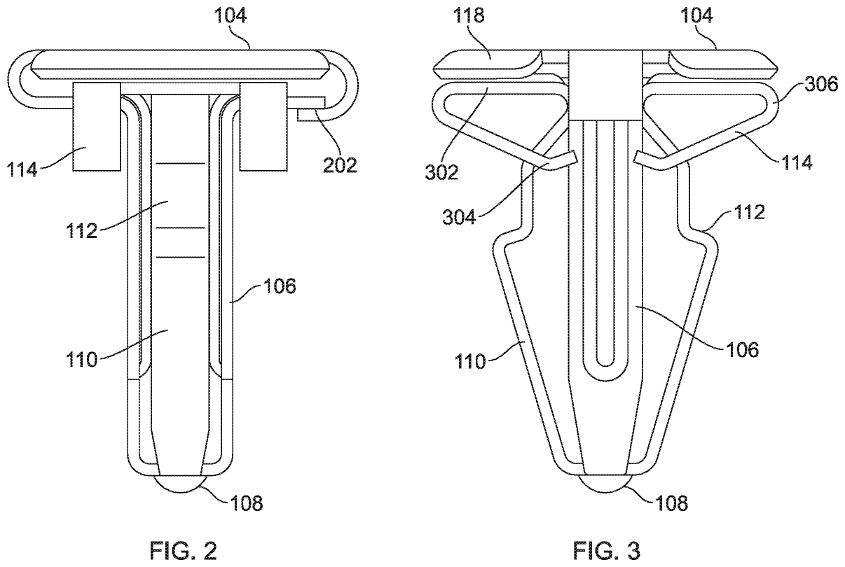

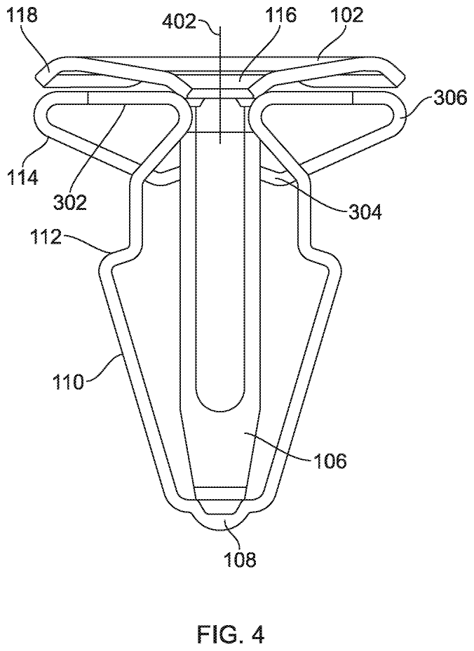

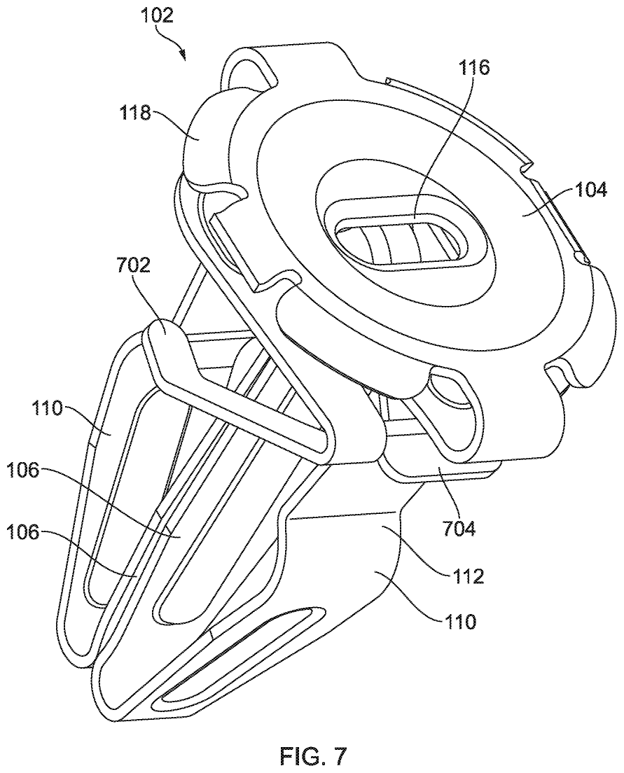

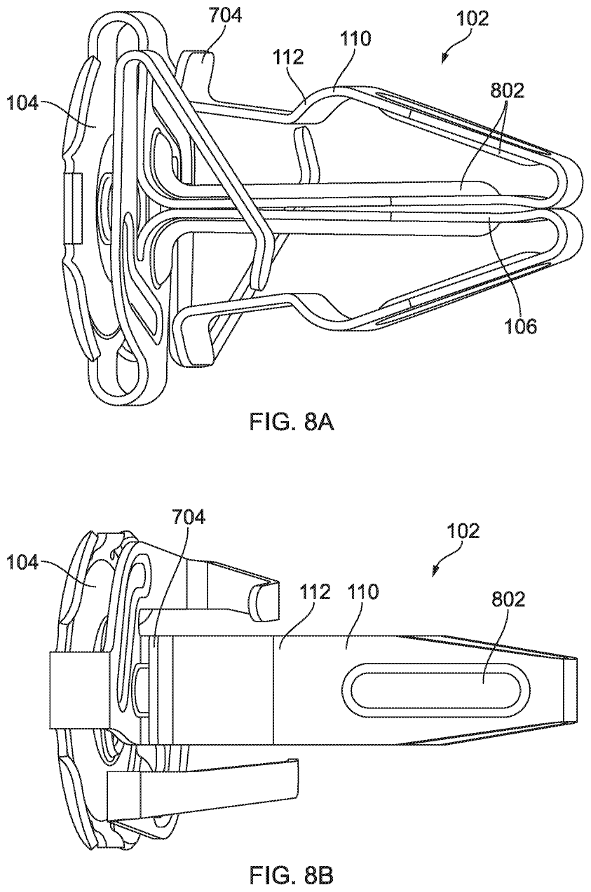

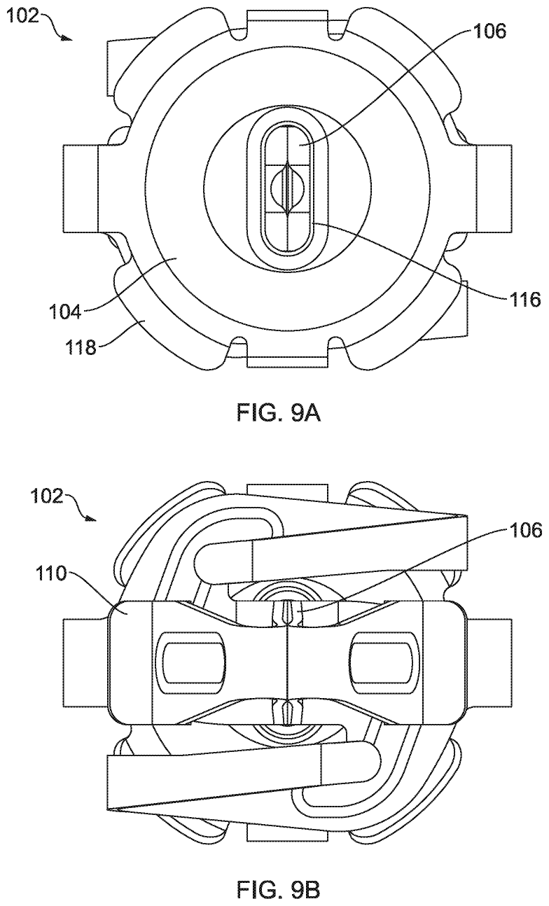

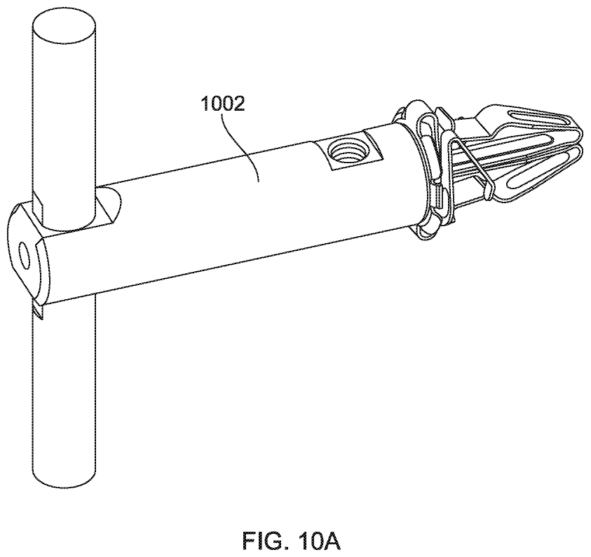

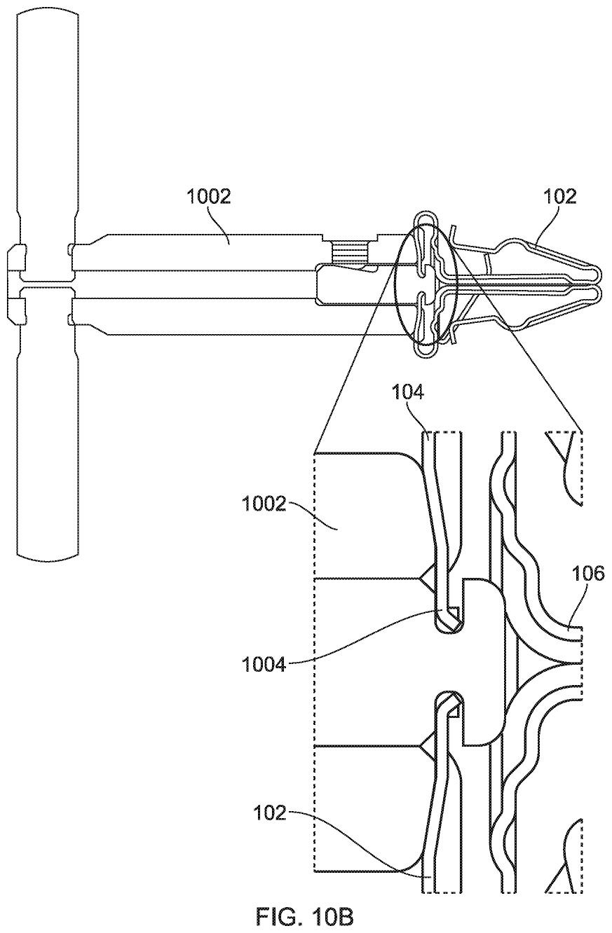

With reference to FIG. 7 to FIG. 10 there is shown an alternative fastener clip, similar to that shown in FIG. 1 to FIG. 6. Like features are provided with like reference numerals to avoid repetition.

The fastener clip differs in the lack of a base. The fins also prevent the clip from passing through an item to which it is attached and separated tensioning fingers (702) are provided to apply a tensioning force to the system to take up slack and absorb vibrations.

As above, the fastener clip is suitable for attaching an element to a vehicle chassis. The fastener clip (102) comprises a top portion (104) which may have an aperture (116) suitable to receive a tool (1002). The top portion may be a cup or cup shaped or not. The tool is intended to assist removal of the fastener clip, not for fitting. The tool allows an extraction force to be applied to the fastener clip to pull the fastener clip free from the item to which it is attached, preferably by hand.

One or more arms (110) are provided in mechanical communication with the top portion. The one or more arms comprise at least one pressure surface (112) arranged to releasable grip (i.e. Hold on to and thereby attach the fastener clip to) a part. The at least one pressure surface is arranged to release a grip upon a part upon a tool applying an extracting force to the aperture (116). The arrangement is provided by ensuring the pressure surfaces are inclined in use (or ramped) relative to the part to which it is fitted, which allows forces to be transmitted to urge the arms towards the central axis (402) when the extraction force is applied to the fastener clip by the tool.

The one or more arms may be connected to the top portion by one or more legs (106). The one or more legs may be connected to a perimeter edge of the top portion, although it will be apparent that any connection point may be used. The perimeter edge is used so that the fastener clip may be formed of a single piece of material, such as via stamping, and also so that the legs do not obscure access to the aperture (116) by a tool (there is sufficient clearance between the aperture and the legs to allow a tool to grip the aperture without fouling upon the legs, despite the legs optionally being arrange coincident with the aperture). As such, the one or more legs may be arranged co-incident with a central axis (402) and/or the aperture by means of folding the legs back under the top portion towards the central axis.

The one or more arms may comprise at least one stop (704) in order to prevent ends of the arms passing through into an item which would hinder extraction. Optionally, the at least one fin is arranged proximately the top portion and/or the at least one fin is located between the top portion and the pressure surface.

The one or more arms can have a shape substantially describing the number “5” with the fin forming the cap of the “5” and the pressure surface forming the bowl (to use terminology describing the anatomy of typefaces).

The pressure surface may comprise a ramped surface. The ramped surface is arranged such that a first end of the ramp, proximate the top portion. is closer to a central axis (402) relative to a second end of the ramp, distal to the top portion. In this way, upon an extraction force being applied to the fastener clip, the ramped surface may urge the arms towards the central axis and allow the pressure surfaces to pull clear of the item in which the fastener clip is located, allowing removal.

The aperture may be provided with a rim (1004), optionally a reinforced rim. The rim allows the tool to securely grasp the aperture minimizing the risk of tearing out or ripping the aperture. Reinforcement can be provided through any suitable means, such as by embossing, providing an eyelet, providing an area of thickened material, or folding/providing surface or topological structure to provide resistance to extraction forces.

The fastener clip can be formed from a single piece of material. Suitable materials include metals, such as steel, although it will be apparent that any suitable material may be used.

The one or more arms, and optionally one or more legs, may comprise embossed areas (802), which, similar to the rim, provide structural reinforcement to prevent unintentional distortion of the arms or legs. Other reinforcement may be suitable, such as providing a thickened area or material, folded material, or other bracing.

The fastener clip may comprise at least one tensioning finger (702). The at least one tensioning finger is arranged between the top portion and the pressure surface in order to, in use, pinch a part between the at least one tensioning finger and the pressure surface to remove any slack in the system and to accommodate a variety of material thickness (e.g., 3 mm to 5 mm) with a single fastener clip. Optionally the at least one tensioning finger is twisted, or obliquely arranged, about a central axis relative to the one or more arms. This is to assist extraction as application of a rotation to the tool during extraction may cause otherwise arranged fingers to foul or interfere with the arms, thereby preventing a successful extraction.

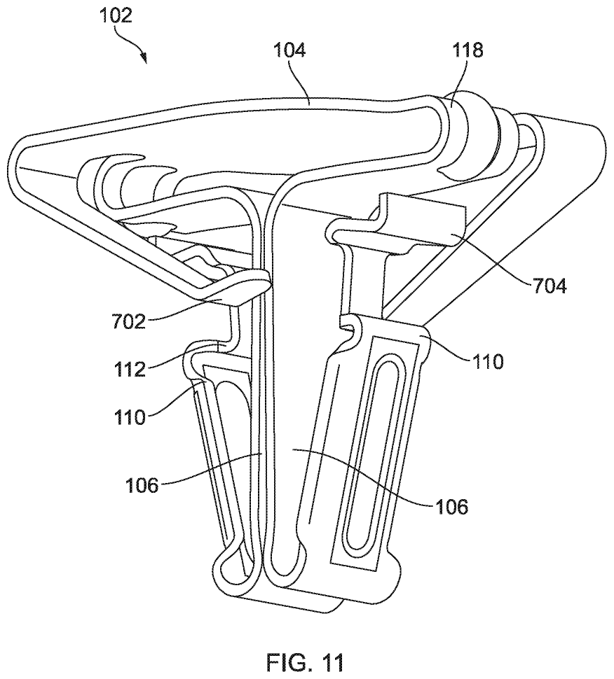

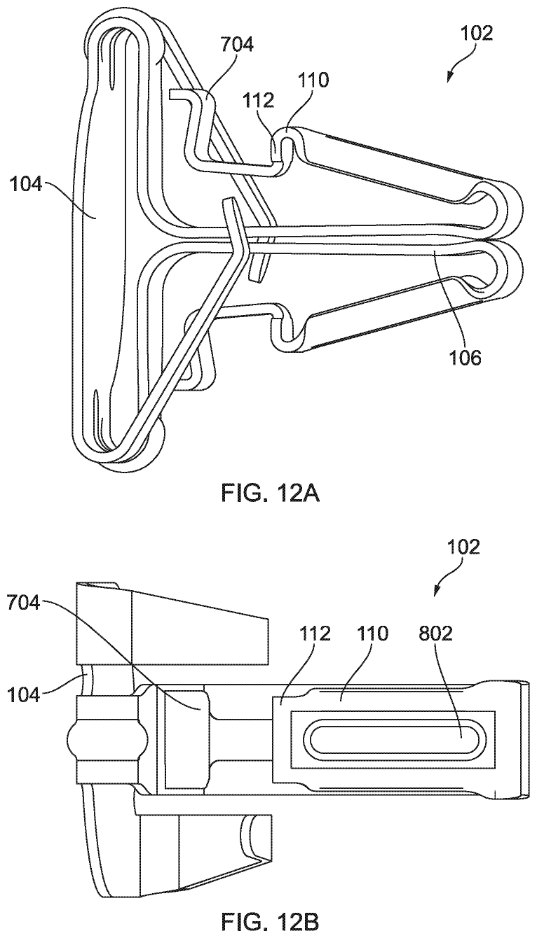

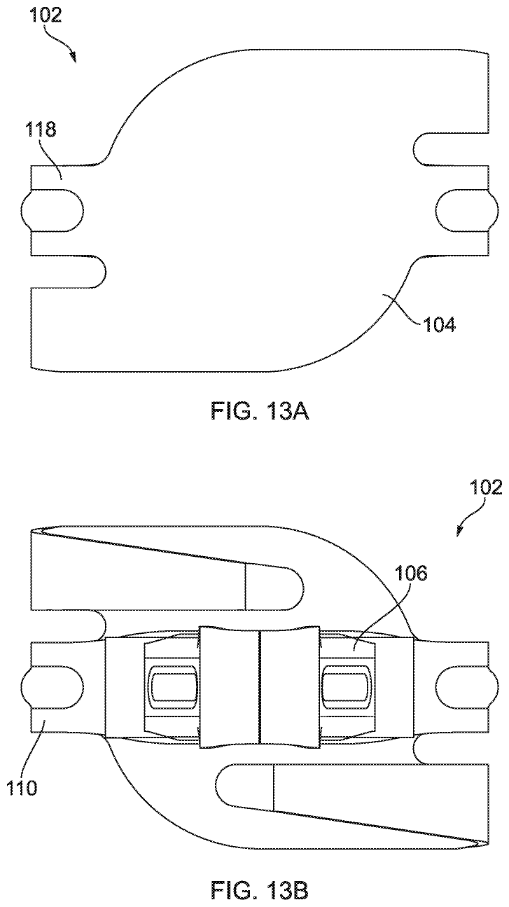

FIG. 11 to FIG. 13 show an alternative fastener clip. Like features are labelled with like reference numerals and not discussed further for the sake of brevity. The top portion 104 has a planar configuration, and like the other fastener clips disclosed herein, is sized to ergonomically receive a press from a finger. No aperture is provided on the top portion; however, the fastener clip may still be removable using a suitable tool. Alternatively, an aperture for a tool may be provided.

Embossed areas 802 are provided on the chamfered edges 118 and/or the arms 110 for increased strength and resilience. Embossed areas 802 may be located at any suitable location.

Further aspects of the present disclosure are presented in the following clauses.

A fastener clip, of the type used in the automotive industry for securing elements to the chassis of vehicles, especially for securing air ducts to the chassis, wherein the clip is composed of a deformed and die-cut metallic sheet having an upper top portion from which legs extend downwards, which, when joined, create a base distant and lower than said top portion, said base being the starting surface for arms that form lower pressure surfaces and upper fins, said assembly fixing the component or accessory to the vehicle chassis, trapping both between said lower pressure surfaces and said upper fins, as in a sandwich.

The fastener clip, according to the preceding clause, wherein said arms are movable in a direction parallel to the surface of said top portion toward the vertical axial axis of the clip.

The fastener clip, according to any one of the preceding clauses, wherein said lower pressure surfaces have a slight inclination, with their section closest to the axial axis of the clip closest to said top portion and their opposite section furthest from it, said inclination being configured to facilitate the extraction of the clip and the overcoming of the edge of the application hole when said arms (110) contract toward the axial axis of the clip.

The fastener clip, according to any one of the preceding clauses, wherein said upper fins are formed from said arms (110) that have a section that approximates the central axis (402) of the clip and from which emerges at least one flat section approximately parallel to said top portion that, by folding itself in the direction of the axial axis of the clip, forms said upper fins.

The fastener clip, according to the preceding clause, wherein said upper fins have elastic mobility in the vertical direction of the clip, said elasticity being configured to adapt to thicknesses of the surfaces to be joined of approximately 3 mm to 6 mm.

The fastener clip, according to any one of the preceding clauses, wherein said descending legs form a unit with each other, without a break in continuity that extends from said top portion to said lower surface, providing greater structural strength.

The fastener clip, according to any one of the preceding clauses, wherein said top portion has chamfered edges and an aperture (116) configured for the passage of a tool for removing the clip, optionally the top portion has a cup shape and/or is a cup.

The fastener clip, according to the preceding clause, wherein said aperture (116) is a slotted hole, that is, rectangular in shape with rounded ends.

The fastener clip, according to any one of the preceding clauses, wherein said clip as a whole forms an inverted prismatic three-dimensional figure, that is, having a “V” shape in section, facilitating insertion into an application hole, starting from its narrow end and whose body progressively widens until reaching the top portion of said clip.

An installation method of the fastener clip described in clause 1, wherein it comprises applying a force to the surface of said top portion, for example with a finger, approximately 45 degrees in the direction of the Clip's aperture (116), said action allowing said lower pressure surfaces to extend beyond the edges of said aperture, opening away from the central axis (402), locking, as in a sandwich, the panels or surfaces to be joined between said lower surfaces and said upper fins.

A method for removing the fastener clip described in clause 1, wherein it comprises inserting a suitable tool, for example a hook, through an aperture (116) provided in said base, which contracts the clip of said arms (110) toward the central axis (402). This action allows the clip to be removed from the application hole when said lower pressure surfaces exceed the edges of said installation hole.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system has been described with reference to certain aspects, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular aspects disclosed. Instead, the present method and/or system will include all aspects falling within the scope of the appended claims, both literally and under the doctrine of equivalents.

What is claimed is:

1. A fastener clip, suitable for attaching an element to a vehicle chassis, the fastener clip (102) comprising:
a top portion (104); and
one or more arms (110) in mechanical communication with the top portion;
wherein the one or more arms comprise at least one pressure surface (112) arranged to releasably grip a part.

2. The fastener clip of claim 1, wherein the top portion has an aperture (116) suitable to receive a tool (1002).

3. The fastener clip of claim 1, wherein the at least one pressure surface is arranged to release a grip upon a part upon a tool applying an extracting force to the fastener clip (102), and optionally, when dependent upon claim 2, upon the aperture (116).

4. The fastener clip of claim 1, wherein the one or more arms are connected to the top portion by one or more legs (106) and optionally wherein
the one or more legs are connected to a perimeter edge of the top portion, and/or
the one or more legs are arranged co-incident with a central axis (402) and/or the aperture.

5. The fastener clip of claim 1, wherein the one or more arms comprise at least one stop (704).

6. The fastener clip of claim 5, wherein the at least one stop is arranged proximate the top portion and/or the at least one stop is located between the top portion and the pressure surface.

7. The fastener clip of claim 1, wherein the one or more arms have a shape substantially describing the number “5”.

8. The fastener clip of claim 1, wherein the pressure surface comprises a ramped surface, optionally wherein the ramped surface is arranged such that a first end of the ramp, proximate the top portion, is closer to a central axis (402) relative to a second end of the ramp, distal to the top portion.

9. The fastener clip of claim 1, where the fastener clip is formed from a single piece of material, and optionally or alternatively wherein the fastener clip is formed from a metal, and optionally or alternatively, wherein the one or more arms, and optionally or alternatively, the one or more legs, comprise embossed areas (802).

10. The fastener clip of claim 1, wherein the fastener clip comprises at least one tensioning finger (702), optionally wherein the at least one tensioning finger is arranged between the top portion and the pressure surface in order to, in use, pinch a part between the at least one tensioning finger and the pressure surface, and optionally or alternatively, wherein the at least one tensioning finger is twisted, or obliquely arranged, about a central axis relative to the one or more arms.

11. A fastener clip for attaching an element to a vehicle chassis, the fastener clip comprising:
a top portion; and
one or more arms coupled to the top portion;
wherein each of the one or more arms includes at least one pressure surface configured to releasably engage a part.

12. The fastener clip of claim 11, wherein the top portion defines an aperture configured to receive a tool.

13. The fastener clip of claim 12, wherein the at least one pressure surface is configured to release engagement with the part in response to an extracting force applied to the fastener clip via the tool through the aperture.

14. The fastener clip of claim 11, further comprising one or more legs extending between the top portion and the one or more arms.

15. The fastener clip of claim 14, wherein the one or more legs are coupled to a perimeter edge of the top portion.

16. The fastener clip of claim 14, wherein the one or more legs are arranged coincident with a central axis of the fastener clip.

17. The fastener clip of claim 11, wherein the one or more arms further includes at least one stop positioned between the top portion and the at least one pressure surface.

18. The fastener clip of claim 11, wherein at least one of the one or more arms has a curved profile approximating the shape of the number “5”.

19. The fastener clip of claim 11, wherein the at least one pressure surface comprises a ramped surface that extends radially outward from a first end proximate the top portion to a second end distal from the top portion.

20. The fastener clip of claim 11, wherein the fastener clip is formed as a unitary, one-piece structure, and further comprises at least one tensioning finger positioned between the top portion and the at least one pressure surface, the at least one tensioning finger configured to bias the part against the pressure surface.
